(19) United States
(12) Patent Application Publication
(10) Pub. No.: US 2021/0268742 A1
(43) Pub. Date: Sep. 2, 2021

(54) STEREOLITHOGRAPHY APPARATUS EQUIPPED FOR OBTAINING USE HISTORY DATA, AND METHOD OF OPERATING THE SAME

(71) Applicant: PLANMECA OY, Helsinki (FI)

(72) Inventors: Tuomas MYLLYLA, Helsinki (FI); Jukka KANERVA, Helsinki (FI); Tero RAKKOLAINEN, Helsinki (FI); Ville VUORIO, Helsinki (FI)

(21) Appl. No.: 17/256,378

(22) PCT Filed: Mar. 11, 2019
(86) PCT No.: PCT/FI2019/050191

§ 371 Date: Dec. 28, 2020

(30) Foreign Application Priority Data
Jun. 28, 2018 (FI) 20185588

(51) Int. Cl. B29C 64/393; B29C 64/255; B29C 64/245; B29C 64/124; B33Y 50/02; B33Y 10/00; B33Y 30/00

(52) U.S. Cl. CPC B29C 64/393; B29C 64/255; B29C 64/245; B33Y 30/00; B33Y 50/02; B33Y 10/00; B29C 64/124

(57) ABSTRACT

A stereolithography apparatus comprises a reader device (501) configured to read an identifier (802) of a vat (401), and a controller (502) coupled to said reader device (501) and configured to receive data read in by said reader device (501). Said data includes use history data of the vat (401) or said controller (502) is configured to read in use history data of the vat (401) from a database external to the vat (401) as a response to reading in the data. Said controller (502) is configured to use a piece of said use history data as a value of an operating parameter of said stereolithography apparatus or to generate an alarm.

### FIELD OF THE INVENTION

The invention concerns the technology of stereolithographic 3D printing, also known as stereolithographic additive manufacturing. In particular the invention concerns conveying use history data to a stereolithography apparatus.

### BACKGROUND OF THE INVENTION

Stereolithography is a 3D printing or additive manufacturing technique in which optical radiation is used to photopolymerize suitable raw material to produce the desired object. The raw material comes to the process in the form of a resin. A vat is used to hold an amount of resin, and a build platform is moved in the vertical direction so that the object to be produced grows layer by layer, beginning on a build surface of the build platform. One vat may be used several times and with different stereolithography apparatuses so that a vat is brought from one apparatus to another. Also different resin material are known to be used in 3D printing processes. The present description concerns in particular the so-called “bottom up” variant of stereolithography, in which the photopolymerizing optical radiation comes from below the vat and the build platform moves upwards during the manufacturing proceeds.

Using a stereolithography apparatus may involve challenges even for inexperienced users.

Particular problems may arise as the bottom of the vat may wear during use. Mechanical wear may be caused e.g. when the object being manufactured is raised from the bottom of the vat. Wear may cause leaking of the resin. Wear as well as residues of resin from a previous manufacturing process may cause inaccuracies or difficulties in a subsequent stereolithography process.

### OBJECTIVE OF THE INVENTION

In the light of challenges when using the same vat over and over again, improved structural solutions and operating practices are needed.

### SUMMARY

The invention is aimed to present a stereolithography apparatus and a method of operating it so that the at least part of the above challenges could be relieved. The invention should enable stereolithographic 3D printing to be automatized to a large extent, and enable convenient and economical handling of resins for stereolithographic 3D printing.

These and other advantageous aims are achieved by equipping the stereolithography apparatus with means for reading in use history data of a vat used in stereolithography apparatus. These means may comprise, for example, an optical imaging detector, the field of view of which covers at least part of the working region of the apparatus.

According to a first aspect, a stereolithography apparatus comprises a reader device configured to read an identifier of a vat, and a controller coupled to said reader device and configured to receive data read in by said reader device. The data includes use history data of the vat or the controller is configured to read in use history data of the vat from a database external to the vat as a response to reading in the data. The controller is configured to use a piece of said use history data as a value of an operating parameter of said stereolithography apparatus or to generate an alarm.

In an embodiment of the stereolithography apparatus the use of the piece of said use history data as a value of an operating parameter relates to a location on the bottom of the vat at which an object is to be manufactured.

In an embodiment of the stereolithography apparatus said reader device is a wirelessly reading reader device configured to perform said reading of use history data without direct physical contact between said reader device and said vat.

In an embodiment of the stereolithography apparatus said reader device comprises at least one of: radio transceiver, optical imaging detector.

In an embodiment of the stereolithography apparatus, wherein said reader device is configured to perform said reading in of use history data when said vat is in said operating position.

In an embodiment of the stereolithography apparatus said reader device is an optical imaging detector directed so that a vat is within a field of view of said optical imaging detector.

In an embodiment of the stereolithography apparatus said field of view of said optical imaging detector encompasses also at least one of: a portion of a resin tank of said stereo-lithography apparatus, a build surface of a build platform of said stereolithography apparatus in at least one position along a working movement range of said build platform.

In an embodiment of the stereolithography apparatus said controller is configured to retrieve the use history data from a computing device using on said read identifier.

In an embodiment of the stereolithography apparatus said controller is configured to store the use history data to said identifier or said computing device using a reader device capable of writing said use history data to a respective location.

In an embodiment of the stereolithography apparatus said controller is configured to use said piece of said received use history data as at least one of the following: providing an alarm of a worn bottom of a vat, correcting and providing correction of geometry based on stretched bottom of a vat.

According to a second aspect, a vat for a stereolithography apparatus comprises an automatically readable identifier containing use history data for use as at least one value of an operating parameter of said stereolithography apparatus.

In an embodiment of the vat said automatically readable identifier comprises at least one of: a radio readable identifier, an optically readable identifier, a radio readable and writeable memory.

According to a third aspect, a method of operating a stereolithography apparatus, comprises using a reader device to read in an identifier of a vat, conveying the read-in data to a controller of said stereolithography apparatus, wherein said data includes use history data of the vat or reading using said controller use history data of the vat from a database external to the vat as a response to reading in the data, and using a piece of said use history data as a value of an operating parameter of said stereolithography apparatus or to generate an alarm.

In an embodiment of the method the use of the piece of said use history data as a value of an operating parameter relates to a location on the bottom of the vat at which an object is to be manufactured.

In an embodiment of the method it comprises storing updated use history data to the identifier, wherein said identifier comprises re-writeable memory. In an embodiment of the method reader device reads an identifier and further reads use history data from a computing device using said identifier.

In an embodiment of the method it comprises storing updated use history data to a computing device.

It is to be understood that the aspects and embodiments described above may be used in any combination with each other. Several of the aspects and embodiments may be combined together to form a further embodiment.

### BRIEF DESCRIPTION OF THE DRAWINGS

The accompanying drawings, which are included to provide a further understanding embodiments and constitute a part of this specification, illustrate embodiments and together with the description help to explain the principles of embodiments. In the drawings:

FIG. 1 illustrates a stereolithography apparatus in a front view with its lid closed,

FIG. 2 illustrates a stereolithography apparatus in a side view with its lid closed,

FIG. 3 illustrates a stereolithography apparatus in a front view with its lid open,

FIG. 4 illustrates a stereolithography apparatus in a side view with its lid open,

FIG. 5 illustrates an example of an operating position of an optical imaging detector in a front view,

FIG. 6 illustrates an example of an operating position of an optical imaging detector in a side view,

FIG. 7 illustrates an example of a working region of a stereolithography apparatus,

FIG. 8 illustrates an example of using graphically represented information on a visible surface of a resin tank,

FIG. 9 illustrates an example of using optical radiators in a front view,

FIG. 10 illustrates an example of using optical radiators in a side view,

FIG. 11 illustrates an example of using an optical radiator to examine a build surface,

FIG. 12 illustrates an example of using an optical radiator to examine a build surface,

FIG. 13 illustrates an example of using an optical radiator to project a pattern upon a vat,

FIG. 14 illustrates an example of using an optical radiator to project a pattern upon a vat,

FIG. 15 illustrates an example of using an optical radiator to measure the amount of resin in a vat,

FIG. 16 illustrates an example of using an optical radiator to measure the amount of resin in a vat,

FIG. 17 illustrates an example of using an optical radiator to measure the amount of resin in a vat,

FIG. 18 illustrates an example of using an optical imaging detector to examine a build surface,

FIG. 19 illustrates an example of a block diagram of a stereolithography apparatus,

FIG. 20 illustrates an example of a method,

FIG. 21 illustrates an example of a method,

FIG. 22 illustrates an example of a method, and

FIG. 23 illustrates an example of a method.

### DETAILED DESCRIPTION

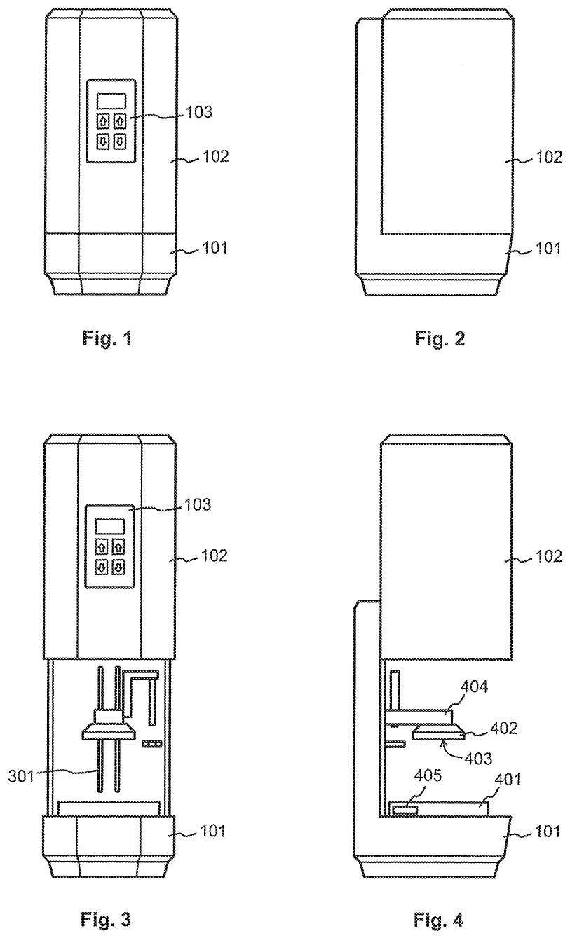

FIGS. 1 to 4 illustrate an example of a stereolithography apparatus. The apparatus could also be called a stereolithographic 3D printer, or a stereolithographic additive manufacturing apparatus. Basic parts of the apparatus are a base part 101 and a lid 102, of which the lid 102 is movably coupled to the base part 101 so that it can move between a closed position shown in FIGS. 1 and 2 and an open position shown in FIGS. 3 and 4. Here the direction of the movement is vertical, but this is not a requirement; the movement of the lid 102 in relation to the base part 101 could take place in other directions. An important advantage of a movable lid of this kind is that an ongoing stereolithographic 3D printing process can be protected from any interfering external optical radiation by closing the lid 102.

A vat 401, which is connectable and removable, is provided in the base part 101 for holding resin for use in the stereolithographic 3D printing process. A build platform 402 with a build surface 403 is supported above the vat 401 so that the build surface 403 faces the vat 401. This arrangement is typical to the so-called “bottom up” variant of stereolithography, in which the photopolymerizing radiation comes from below the vat. The bottom of the vat 401 is or can be selectively made transparent or translucent for the kind of radiation used for said photopolymerizing. In the described embodiments the vat 401 comprises an identifier 405. The identifier may be a read/write-memory, optical marking or similar.

A moving mechanism is provided and configured to move the build platform 402 in a working movement range between first and second extreme positions. Of these, the first extreme position is the one proximal to the vat 401, and the second extreme position is the one distant from the vat 401. In the first extreme position the build surface 403 is very close to the bottom of the vat 401. The first layer of the object to be manufactured will be photopolymerized onto the build surface 403 when the build platform 402 is in the first extreme position. Consequently, in said first extreme position the distance between the build surface 403 and the bottom of the vat 401 is in the order of the thickness of one layer in the stereolithographic 3D printing process.

The position shown in FIGS. 3 and 4 may be the second extreme position, or at least closer to the second extreme position than to the first extreme position. A working region of the stereolithography apparatus may be said to exist between the vat 401 and the second extreme position of the build platform 402, because the object to be manufactured will appear within this region. The build platform 402 does not need to move up to or even close to the second extreme position during the manufacturing of an object; the second extreme position may be most useful for making it easier to detach a manufactured object from the build platform 402 once the object is complete.

In the embodiment of FIGS. 1 to 4 the moving mechanism for moving the build platform 402 is inside the base part 101, and only represented by the two slits 301 seen in a vertical surface of the base part 101, as well as the horizontal support 404 of the build platform 402. There is also a similarly hidden moving mechanism for moving the lid 102 with respect to the base part 101. This second moving mechanism may comprise parts inside the base part 101 and/or parts inside the lid 102. Enclosing essentially all moving mechanisms within the casings of the base part 101 and/or the lid 102 involves the advantage of added safety, because it makes it improbable that a user could get injured by any moving parts of such mechanisms.

The horizontal support 404 of the build platform 402 is shown only schematically in the drawings. In a practical implementation a support of the build platform 402 may comprise various advanced technical features, like joints and/or fine tuning mechanisms for ensuring that the orientation of the build surface 403 is appropriate. However, such features are out of the scope of this description and are therefore omitted here.

Another feature of the exemplary stereolithography apparatus of FIGS. 1 to 4 is a user interface, which comprises a touch-sensitive display 103 in the lid 102. The user interface may comprise various functions for implementing interactions between the apparatus and its user, including but not being limited to buttons for controlling the movements of the lid 102 and the build platform 402. A touch-sensitive display is an advantageous feature of a user interface in particular if the stereolithography apparatus is to be used in environments where thorough cleaning and disinfecting are regularly required, like at medical and/or dental clinics. Placing a touch-sensitive display 103 and/or other parts of the user interface in a front part of the lid 102 is advantageous, because it makes such parts of the user interface easily accessible to the user. As such, at least some parts of the user interface could be implemented in the base part 101.

Significant advantage can be gained by providing the stereolithography apparatus with an optical imaging detector, installed and directed so that at least a part of the working region is within the field of view of the optical imaging detector. If the optical imaging detector is movable between at least one operating position and some other positions, the working region should appear within the field of view of the optical imaging detector at least when the optical imaging detector is in said operating position. An optical imaging detector is a device that is capable of producing optical image data indicative of what can be optically detected within its field of view. Most optical imaging detectors can be characterized as (digital) cameras, but there are e.g. optical imaging detectors working on other wavelengths than visible light, which may not necessarily be commonly referred to as cameras. In order to maintain general applicability the term optical imaging detector is used in this description.

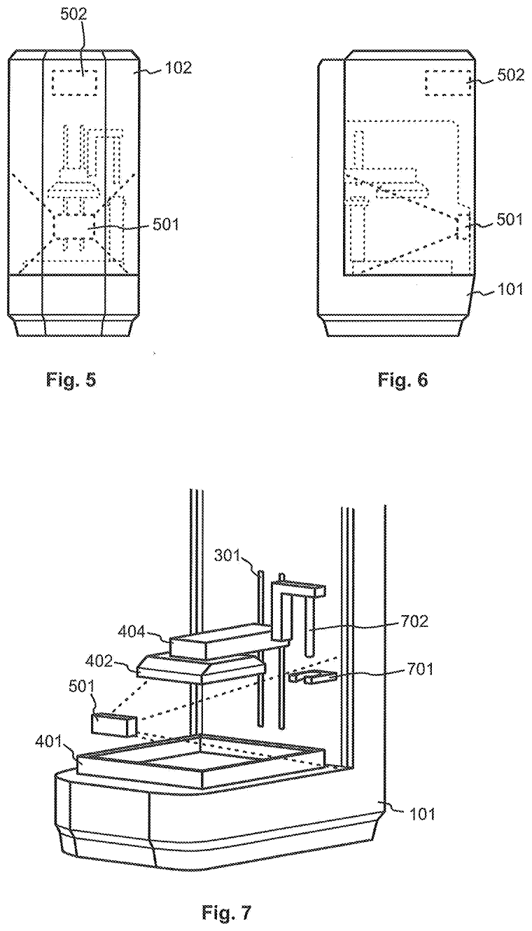

FIGS. 5 and 6 illustrate schematically an example of how an optical imaging detector 501 may be installed on the inside of the lid 102. Closing the lid 102 brings the optical imaging detector 501 into an operating position, in which at least a part of the working region is within its field of view. This is illustrated also in FIG. 7, in which the lid is omitted for graphical clarity. The optical imaging detector 501 could be placed in some other part of the lid 102 than what is shown schematically in FIGS. 5 and 6. A yet further alternative way of supporting the optical imaging detector 501 would be to fix it to the base part 101, for example through a telescopic or foldable support arm so that a user could move it aside when not needed, or so that the stereolithography apparatus could automatically bring the optical imaging detector to the operating position only when needed. The optical imaging detector 501 could also be installed somewhere in the same vertical surface that has the slits 301 along which the support 404 moves the build platform 402.

The stereolithography apparatus shown in FIGS. 5 and 6 comprises a controller 502 coupled to the optical imaging detector 501 for receiving optical image data from the optical imaging detector 501. The controller 502 may be configured to use such optical image data in controlling operation of the stereolithography apparatus. Examples of such controlling are described in more detail later in this text. The coupling between the optical imaging detector 501 and the controller may be a wired coupling or a wireless coupling, or it may comprise both wired and wireless elements either as alternatives of each other or augmenting each other.

The controller 502 is shown as installed in the lid 102 in FIGS. 5 and 6, but it could alternatively be installed in the base part 101. The controller functionality could even be distributed so that some parts of it could be implemented with circuits located in the lid 102 while other parts of the controller functionality could be implemented with circuits located in the base part 101. Placing the controller in the lid 102 may be advantageous if also a significant portion of the other electronics, like the user interface, is placed in the lid 102, because wiring may become simpler. The user interface is not shown in FIGS. 5 and 6 in order to enhance graphical clarity.

The controller 502 may be configured to execute a machine vision process to recognize objects from the optical image data it receives from the optical imaging detector 501. The optical image data is essentially a digital representation of an image recorded by the optical imaging detector 501, and machine vision in general means extracting information from an image. Thus by executing a machine vision process the controller 502 is capable of extracting information that enables recognizing various objects seen by the optical imaging detector 501. The controller 502 may be configured to make decisions based on such recognized objects.

In the example disclosed above the optical imaging detector 501 is configured to detect an identifier 405 associated with a vat 401. The controller 502, which is equipped with a network connection, is configured to retrieve use history data of the vat 401 based on the identifier 502. The use history data is retrieved from a computing device, such as a local server, central server or a cloud computing facility.

In this specification, “use history data” of a vat may refer to data, which may be time-stamped, related to usage of said vat gathered and/or recorded during, for example, throughout, the course of an operating life of said vat. Such use history data may generally comprise piece(s) of data related to any relevant aspects of usage of said vat, for example, data related to resin(s) and/or stereolithography process parameters used with said vat; data related to locations on a bottom of said vat at which objects have been manufactured; data related to error situations and malfunctioning of said vat, a stereolithography apparatus wherein said vat has been used, and/or part(s) thereof; and/or data related to repairs and/or modifications of said vat.

One vat may be used with several stereolithography apparatuses and one stereolithography apparatus may be used with several different vats. Thus, each of the vats has an identifier number that is unique at least within the facility where it is used so that the use history of each vat can be traced.

Thus, when a vat is connected to a stereolithography apparatus the use history is read and after the use the updated use history is stored. In the example disclosed above the use history is stored in a computing device, however, it is possible that instead of optical reader a device that can read and write a memory attached to the vat 401 is used. In such case the identifier carries the use history with the vat 401.

The use history of a vat may be used in several ways. One common example is to determine the material used with a vat 401. Thus, if the stereolithography apparatus chooses a material it is typically desired that the vat 401 is new or has been used only with the same material. Another example of common use is to determine the position of the object to be constructed on the bottom of the vat 401 so that the bottom of the vat 401 is equally used. This improves the life time of a vat as all positions on the bottom have been used and no unused locations are left. The improvement of life time not only reduces costs but also provides better quality in manufacturing when objects are constructed on locations where the bottom of the vat 401 is still in good shape.

Another example of an object that the controller 502 may recognize is a resin tank, or a piece of graphically represented information carried by a resin tank. In order to provide some background for this kind of applications, the task of resin handling is described in some more detail in the following.

The resin that is to be used in the stereolithographic 3D printing process may be brought to the stereolithography apparatus in a resin tank. The designation “resin tank” is used in this text as a general descriptor of any kinds of containers that may hold resin in readiness for the resin to be used in a stereolithographic 3D printing process. The stereolithography apparatus may comprise a holder for removably receiving a resin tank to an operating position in the stereolithography apparatus. An example of such a holder is illustrated in FIG. 7 with the reference designator 701. Providing a holder for removably receiving a resin tank involves the advantage that the user may easily exchange resin tanks to ensure the use of the most optimal resin for each stereolithographic 3D printing job.

A resin tank that can be removably received in the holder 701 may have the form of an elongated capsule, preferably with a cover or plug covering an opening in one end, and with an outlet appearing in the other end. The outlet may be equipped with a valve, seal, plug, or some other means that keep the resin from escaping the resin tank unless explicitly desired. Such an elongated, capsule-formed resin tank can be removably received in the holder 701 so that the end with the opening is upwards, and the outlet is in or close to the vat 401.

In the example embodiment of FIG. 7 a piston 702 is attached to the same support 404 as the build platform 402. When the build platform 402 moves downwards in order to assume the first extreme position, which is the starting position for producing a new object, the piston 702 moves downwards in concert with the build platform 402. This movement of the piston 702 pumps the resin out of the resin tank that was received in the holder 701, so that the resin flows out of the outlet and into the vat 401. The cover or plug that covered the opening in the upper end of the resin tank must naturally have been removed before that, as well as the means that closed the outlet unless some mechanism is provided that automatically opens the outlet when needed.

It must be noted that making the piston 702 move in concert with the build platform 402 is only an example implementation. It involves the advantage that only one moving mechanism is needed to move two parts. However, in some applications it may be desirable to be able to control the delivery of resin into the vat 401 independently of the movement of the build platform 402. For such applications an embodiment can be presented in which there are separate mechanisms for moving the build platform 402 and for delivering resin from a resin tank to the vat 401. Such a separate mechanism may involve for example a piston that is otherwise like the piston 702 in FIG. 7 but supported and moved by a moving mechanism of its own.

Only one holder 701 for one resin tank is shown in the drawings, but the stereolithography apparatus may comprise two or more holders, and/or a single holder may be configured to receive two or more resin tanks. In particular if there are separate mechanisms for pumping resin from different resin tanks to the vat 401, the provision of places for receiving multiple resin tanks involves the advantage that different resins can be used automatically, even during the manufacturing of a single object. Such a feature may be useful for example if the object to be manufactured should exhibit a sliding change of color. The stereolithography apparatus might comprise two tanks of differently pigmented resin, and these could be delivered to the vat in selected proportions so that the resulting mix of resins in the vat would change its color accordingly.

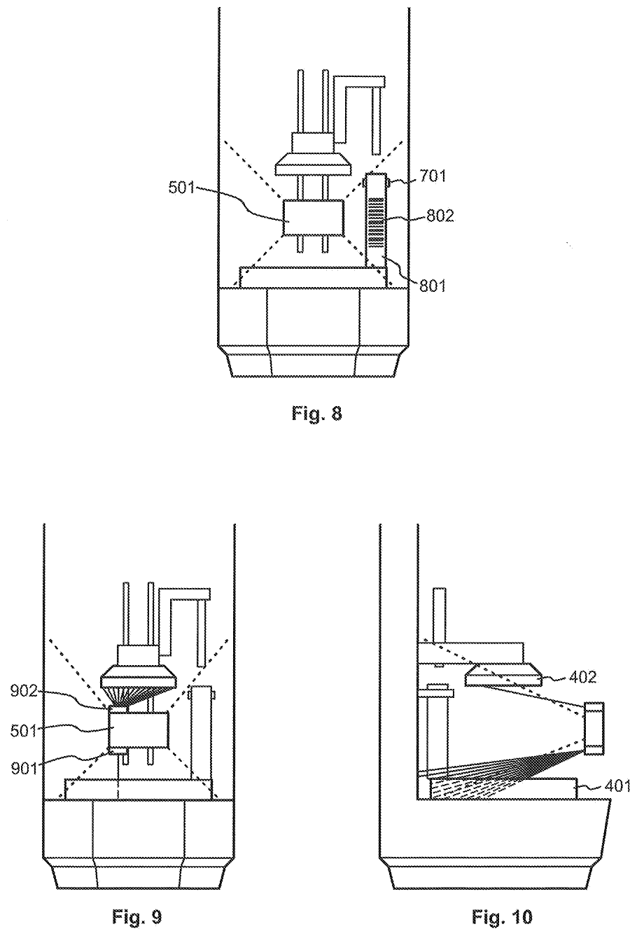

FIG. 8 illustrates schematically a case in which a resin tank 801 has been received in the holder 701. A visible surface (visible in the field of view of the optical imaging detector 501) of the resin tank 801 is provided with a piece 802 of graphically represented information. In the example of FIG. 8 a barcode is used, but any other form of graphically represented information could be used, like a QR code or a color or color combination of the resin tank 801 or a part of it. The use of graphically represented information involves the advantage that it can be read with an optical imaging detector, for which there may be also other advantageous uses in the stereolithography apparatus.

The information carried by the piece 802 of graphically represented information is or reveals advantageously something that is pertinent to just that resin that is contained in that particular resin tank 801. Additionally or alternatively the information carried by the piece 802 of graphically represented information may be or reveal something that is pertinent to that particular resin tank itself. Said information may contain for example one or more of the following: an identifier of resin contained in the resin tank 801, an indicator of amount of resin contained in the resin tank 801, a manufacturing date of resin contained in the resin tank 801, a best before date of resin contained in the resin tank 801, unique identifier of the resin tank 801, a digital signature of a provider of resin contained in the resin tank 801.

As an interesting special case, the information carried by the piece 802 of graphically represented information may contain a piece of parameter data. The controller 502, on the other hand, may be configured to use such a piece of parameter data as a value of an operating parameter of the stereolithography apparatus. Examples of such operating parameters include but are not limited to the following: a preheating temperature of resin, a layer exposure time, a layer thickness, a moving speed of a build platform, or a waiting time between two successive method steps in stereolithographic 3D printing.

The concept of using a removably attachable resin tank to convey a value of an operating parameter to the stereolithography apparatus can be generalized to cover other than graphically represented information. Examples of such other ways include but are not limited to using various kinds of memory circuits attached to and/or embedded in the material of such a resin tank. In a general case the resin tank comprises an automatically readable identifier of the resin tank, and the stereolithography apparatus comprises a reader device configured to read in parameter data from an automatically readable identifier of a resin tank. The reader device may comprise contact members in the holder 701 so that receiving a resin tank in the holder simultaneously connects the reader device to said automatically readable identifier. Alternatively the reader device may be a wirelessly reading reader device configured to perform said reading of parameter data without direct physical contact between said reader device and said resin tank. Examples of such wirelessly reading reader devices are radio transceivers (using e.g. NFC, Bluetooth, or other short-distance radio transmission technology) and optical imaging detectors. The reader device may comprise multiple contact-based and/or wireless technologies for accommodating different kinds of automatically readable identifiers in resin tanks.

Further in said general case the stereolithography apparatus comprises a controller coupled to the reader device and configured to receive parameter data read in by said reader device. Said controller may be configured to use a piece of said received parameter data as a value of an operating parameter of said stereolithography apparatus.

This way of conveying values of operating parameters involves for example the advantage that new kinds of resins may be brought into use, without the need to preprogram an automatically operating stereolithography apparatus for their most appropriate handling. In comparison, we might consider a case in which the piece 802 of graphically represented information contained just a specific identifier of the kind of resin contained in the resin tank. In such a case the controller 502 should have access to a library of previously stored parameter data, so that after having recognized the particular resin, it could read the corresponding most appropriate values for operating parameters from the library and take them into use. Conveying one or more values of parameter data in the piece 802 of graphically represented information enables more flexible operation, because such a library is not needed at all or because only a limited library of parameter values is needed for those cases in which not all parameter values can be read from the piece 802 of graphically represented information.

As such, it is not excluded that the stereolithography apparatus might have an access to an external database of parameter data and other information concerning resins and resin tanks. Correspondingly, stereolithography apparatus might have an access to an external database, cloud service or similar source of use history data. For example, if a facility has two or more stereolithographic apparatuses in which at least some of the same resin tanks or vats may be used in turns, it may be advantageous to have a shared database that contains information about the vats, the resin tanks and the resins they contain. In such a case the controller 502 could respond to receiving image data in which a graphical identifier of a resin tank or vat is found by accessing the database in order to obtain information about the vat, resin or resin tank and/or to update the database with information concerning what the stereolithography apparatus currently does with that vat, resin or resin tank.

In an embodiment, a stereolithography apparatus comprises a reader device configured to read an identifier of a vat, and a controller coupled to said reader device and configured to receive data read in by said reader device. The controller is configured to read in use history data of the vat from a database external to the vat as a response to reading in the data. The controller is configured to use a piece of said use history data as a value of an operating parameter of said stereolithography apparatus or to generate an alarm.

In another embodiment, a stereolithography apparatus comprises a reader device configured to read an identifier of a vat, and a controller coupled to said reader device and configured to receive data read in by said reader device. The data includes use history data of the vat. The controller is configured to use a piece of said use history data as a value of an operating parameter of said stereolithography apparatus or to generate an alarm.

Irrespective of whether the reader device is contact-based or wirelessly reading, the reader device may be configured to perform the reading in of parameter data when the vat or resin tank is in an operating position in a holder. In the case of using an optical imaging detector as the reader device this may mean that the optical imaging detector is directed so that a vat or resin tank, which was removably received to the holder, is within a field of view of the optical imaging detector.

If the reader device comprises an optical imaging detector, the previously mentioned machine vision process may be utilized so that the controller, which is coupled to the optical imaging detector for receiving optical image data from the optical imaging detector, is configured to execute said machine vision process to recognize a piece of graphically represented information carrier by a resin tank that was received in the holder. The controller may be configured to extract parameter data from said recognized piece of graphically represented information, and to use a piece of said extracted parameter data as a value of an operating parameter of said stereolithography apparatus.

In order to ensure that the user will always attach the resin tank 801 in the right way, so that the piece 802 of graphically represented information is visible to the optical imaging detector 501, the holder 701 may comprise a mechanical key for forcing the resin tank 801 to be received to the stereolithography apparatus in a predetermined orientation. The resin tank 801 should then comprise a reciprocal slot for such a mechanical key, for forcing said resin tank to be attached to the stereolithography apparatus in the predetermined orientation. The roles of a mechanical key and reciprocal slot could be exchanged, so that the resin tank comprises a mechanical key and the holder comprises a reciprocal slot. Here the terms mechanical key and reciprocal slot are used in a general sense, meaning any kinds of mutually engaging mechanical designs in the holder 701 and the resin tank 801 that serve the purpose of guiding a user to attach the resin tank to the stereolithography apparatus in the predetermined orientation. There may be one, two, or more pairs of mechanical keys and reciprocal slots used for this purpose.

The use of an optical imaging detector as a reader device involves the particular advantage that the same optical imaging detector can be used also for other purposes in the stereolithography apparatus. Such other purposes may even substantiate the provision of an optical imaging detector even if it is not used for reading graphically represented information from resin tanks. Some of such advantageous other purposes are described in the following.

Another advantage of the use of an optical imaging detector is that when the use history of each vat is stored in a computing device there is no need to provide more expensive and complicated reader/writer device for detecting and also the identifiers used with vats can be simple read-only tags instead of re-writeable memories that are prone for tear and wear.

FIGS. 9 and 10 illustrate schematically a part of a stereolithography apparatus that comprises a first optical radiator 901 and a second optical radiator 902. In the drawings the optical radiators 901 and 902 are shown as being located in a common optical module with the optical imaging detector 501, but this is only an example, and any or both of them could be placed elsewhere in the stereolithography apparatus. It is possible that the stereolithography apparatus only comprises one of the first 901 and second 902 optical radiators, or none of them if the optical imaging detector 501 is used only for other purposes. It is also possible that the stereolithography apparatus comprises more than two optical radiators.

The first optical radiator 901 is configured to project a pattern upon a portion of the vat 401. In other words, at least some of the optical radiation emitted by the first optical radiator 901 hits some portion of the vat 401. The affected portion of the vat 401 is within the field of view of the optical imaging detector 501 when said optical imaging detector 501 is in its operating position (i.e. when the lid of the stereolithography apparatus, on the inside of which the optical imaging detector 501 is installed, is in its closed position). As was pointed out earlier, the optical imaging detector 501 does not need to be installed in the lid of the stereolithography apparatus, but it could be installed elsewhere. For the purpose described here it is only required that the optical imaging detector is installed and directed so that said portion of said vat, onto which the first optical radiator 901 projects a pattern, is within the field of view when said optical imaging detector is in an operating position.

The controller of the stereolithography apparatus is not shown in FIGS. 9 and 10, but one is assumed to exist and to be coupled to the optical imaging detector 501 for receiving optical image data. The controller is configured to use said optical image data to calculate an amount of resin in the vat 401.

The principle of using optical image data for calculating how much resin there is in the vat 401 is based on the fact that the optical radiation emitted by the first optical radiator 901 reflects differently from resin than from a clean surface of the vat. To this end the first optical radiator 901 should project the pattern to such portion of the vat 401 that is covered differently by resin depending on how much resin there is in the vat. It also helps if the projected pattern is as sharp by outline as possible. In order to achieve the last-mentioned objective it is advantageous if the first optical radiator 901 is a laser, configured to project at least one distributed reflection of laser light upon said portion of the vat 401.

A distributed reflection could be called also a spatially distributed reflection. It means a reflection that consists of more than just a single spot (which would be produced by a single laser beam as such). Distributed reflections of laser light can be produced for example by physically turning the laser source, and/or by using at least one laser source and at least one lens configured to distribute a linear laser beam produced by said laser source into a shape, like a fan-like shape or conical shape for example. A fan-like shape is considered in FIGS. 9 and 10 as an example: in FIG. 9 the view is in the plane of the fan, for which reason the fan-like shape of distributed laser light is seen as a single line. In FIG. 10 the view is perpendicular to the plane of the fan, so that the fan-like shape is clearly seen.

FIG. 13 is a simplified axonometric drawing of a vat 401, an optical imaging detector 501, and a first optical radiator 901, with the slits 301 seen in the background as a reminder of how said parts are located in the stereolithography apparatus. There is no resin in the vat 401 in FIG. 13. The portion of the vat 401, onto which the first optical radiator 901 projects its pattern, comprises a portion of a rim 1301 of the vat 401. The first optical radiator 901 is configured to project a distributed reflection upon the rim 1301 so that the reflection extends from an edge of said rim 103 linearly towards a bottom 1302 of the vat 401.

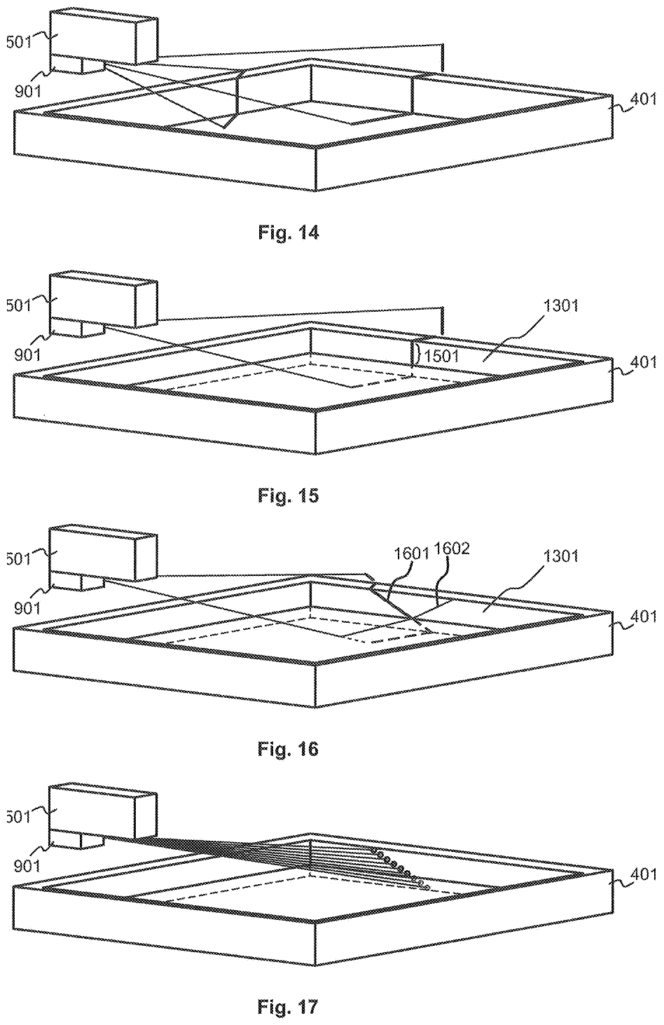

FIG. 14 shows an example of how the first optical radiator 501 may project more than one pattern onto more than one portion of the vat 401. In FIG. 14 the first optical radiator 901 is configured to project at least two separate distributed reflections of laser light upon said rim: there are two laser beams, each distributed into a fan-like shape, so that each distributed reflection extends from an edge of the rim linearly towards a bottom of the vat 401.

In FIG. 15 the situation is otherwise the same as in FIG. 13, but there is some resin in the vat 401. Here it is assumed that resin absorbs relatively effectively the laser light emitted by the first optical radiator 901, while the material of the vat 401 is a relatively good reflector so that a very clear and sharp reflection appears on its surface. The length of the linear reflection 1501 tells, how much of the rim 1301 is dry (i.e. not wetted by resin). When the dimensions of the vat 401 are known, measuring the length of the linear reflection 1501 is enough to calculate the amount of resin in the vat 401. In general it can be said that the controller, which is coupled to the optical imaging detector 501 to receive optical image data, is configured to recognize an image of said projected pattern from said optical image data, and configured to calculate the amount of resin held in the vat 501 from one or more detected dimensions of said image of said projected pattern.

The controller of the stereolithography apparatus may be configured to execute a machine vision process to implement the steps listed above. The controller could first find and select at least one image taken by the optical imaging detector 501 in which an observed pattern appears upon the affected part of the vat 401. In said at least one image the controller could examine the coordinates, within the coordinate system of the image frame, of those pixels that contribute to the observed pattern. The controller could find the coordinates of those pixels that appear to represent the extremities of the observed pattern, and calculate the difference between these coordinates. Mapping the calculated difference against a look-up table of possible calculated differences, or executing some other form of a decision-making algorithm, may give the measured amount of resin the vat as a result.

A common feature in FIGS. 13 to 15 is that the laser in the first optical radiator 901 is configured to project the at least one distributed reflection upon the rim so that the reflection extends from a horizontal edge of said rim perpendicularly towards a bottom of the vat. In other words, the linear reflection 1501 is a vertical line on the rim 1301 of the vat 401. This is not the only possibility. FIG. 16 illustrates schematically an alternative embodiment, in which the laser is configured to project said at least one distributed reflection upon said rim so that it extends from a horizontal edge of said rim obliquely towards a bottom of said vat. In other words, in FIG. 16 the linear reflection 1601 on the rim 1301 is obliquely directed.

A geometry like that in FIG. 16 offers a number of advantages, because the optical image data produced by the optical imaging detector 501 contains more features to be analyzed than in the case of FIG. 15. Changes in the level of the resin in the vat cause larger changes in the linear reflection 1601 of the fan-shaped laser beam on the surface of the rim 1301 than in FIG. 15. This may make it easier to detect even smaller changes in the amount of resin in the vat 401. Also, if the surface of the resin is smooth and reflective enough, one may observe a secondary reflection 1602 on the surface of the rim 1301, so that the corner point between reflections 1601 and 1602 indicates quite accurately the level of the resin surface in the vat 401. If the machine vision process recognizes such a corner point, it may give quite accurate results in calculating the amount of resin in the vat 401.

FIG. 17 illustrates yet another alternative embodiment, in which the pattern, i.e. the distributed reflection, is not continuous but consists of distinct spots. Even if the spots are arranged in a linear form in FIG. 17, this is not a requirement, but the pattern may be of any shape that makes it possible to calculate, by observing how the pattern differs from one obtained from a completely empty vat, and by knowing the dimensions of the vat, the amount of resin currently in the vat.

Enabling the stereolithography apparatus to automatically detect the surface level of resin in the vat involves a number of advantages. As an example, before pumping more resin into the vat the apparatus may check, how much resin (if any) is there already. Since the resins may be relatively expensive, and since it may be cumbersome to draw any resin back into any kind of tank or other long-term repository, it is advisable to always use up all resin that was already pumped into the vat. This is more or less synonymous to only delivering as much new resin, to augment any already present in the vat, as is needed to complete the next known task of stereolithographic 3D printing. For a piece of control software that receives instructions to manufacture a particular three-dimensional object it is relatively straightforward to calculate the volume of the object to be manufactured. The calculated volume is then the same as the amount of resin that will be needed to actually manufacture the object.

Taken that stereolithography is based on photopolymerizing only some strictly delimited portions of resin, care should be taken not to use such optical radiators for other purposes (like measuring the amount of unused resin in the vat) that could cause unintended photopolymerization. Therefore it is advisable to select the first optical radiator 901 so that it is configured to only emit optical radiation of wavelengths longer than or at most equal to a predefined cutoff wavelength. Said cutoff wavelength should be selected longer than wavelengths used to photopolymerize resins in stereolithography. Ultraviolet radiation is often used for photopolymerizing, so said cutoff wavelength could be in the range of visible light. Laser light is monochromatic, so if a laser source is used in the first optical radiator 901, the wavelength of the laser light is synonymous to said cutoff wavelength. Naturally the wavelength of the first optical radiator 901 must be selected so that its reflection is easily detectable by the optical imaging detector 501.

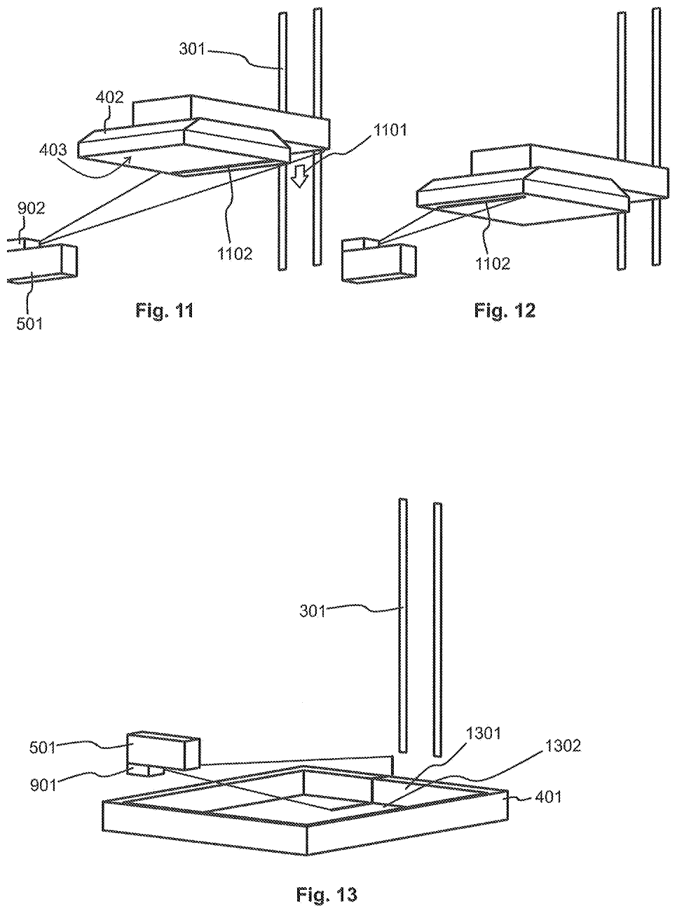

Another purpose for which an optical imaging detector 501—together with a second optical radiator 902—can be used in a stereolithography apparatus is shown in FIGS. 11 and 12. To provide some background, it may be noted that the build surface 403 of the build platform 402 will come very close to the bottom of the vat in the beginning of a stereolithographic 3D printing job. To this end, the build surface 403 should be appropriately directed, and clean of any pieces of any solid substance, before the build platform 402 is lowered into the starting position, which is the first extreme position mentioned earlier. Unfortunately it may happen that the user has forgotten to detach the previously manufactured object from the build surface 403. Even if the user has detached the actual object that was manufactured previously, it may happen that some solid parts remain on the build surface 403. These may be for example support strands or bridges that had to be produced as a part of the previous 3D printing job for providing mechanical stability, even if they did not form part of the actual object to be manufactured.

Moving the build platform into the first extreme position with anything solid attached to the build surface may have serious consequences, like breaking the bottom of the vat or damaging the moving mechanism and/or support structure of the build platform. One possible protective measure might be monitoring the load experienced by the moving mechanism when the build platform is moved towards the first extreme position and stopping the movement if the load seems to increase. However, observing an increasing load in the moving mechanism means that contact was made already between the undesired solid remnants on the build surface and the bottom of the vat, so it may be too late already.

FIGS. 9 to 12 illustrate a principle of using a (second) optical radiator 902 and the optical imaging detector 501 to set up protective measures that help to prevent any accidental moving of the build platform 402 too close to the bottom of the vat 401 if there are any unwanted solid remnants on the build surface 403. Said principle is based on using the second optical radiator 902 to project a pattern onto the build surface 403 while it is in the field of view of the optical imaging detector 501, and examining said pattern to determine, whether the observed form of the pattern indicates that there could be anything else than just the planar surface there that should be.

From the previous description it may be recalled that the stereolithography apparatus comprises a moving mechanism configured to move the build platform 402 in a working movement range between first and second extreme positions. The second optical radiator 902 is configured to project a pattern upon the build surface 403 when the build platform 4302 is in at least one predetermined position between said first and second extreme positions. The optical imaging detector 501 is installed and directed so that said projected pattern is within its field of view when the build platform 402 is at said predetermined position. A controller of the stereolithography apparatus is coupled to the optical imaging detector 501 for receiving optical image data from the optical imaging detector 501. The controller is also configured to use said optical image data to examine the build surface 403 for exceptions from a default form of the build surface.

In order to be sure that no part of the build surface 403 contains any unwanted solid remnants, it would be advantageous to cover the whole build surface 403 with the projected pattern. This can be done for example by using a laser source and a lens that distributes the laser beam into a regular two-dimensional matrix of dots close to each other. A machine vision algorithm could then analyze the image taken by the optical imaging detector 501 to tell, whether there is any irregularity in the array of dots seen in the image.

A slightly different approach is taken in the embodiment of FIGS. 9 to 12. The second optical radiator 902 is configured to project said pattern upon an affected part of the build surface 403, and this affected part changes position across the build surface 403 when the build platform 402 moves through a range of positions on its way between the first and second extreme positions according to arrow 1101 in FIG. 11.

Said range of positions does not need to occupy the whole range between the first and second extreme positions, but preferably only a small sub-range thereof. However, throughout this range of positions the optical imaging detector 501 should see at least that part of the build surface 403 where the projected pattern appears. In other words, each position within said range of positions must be a predetermined position as described above, i.e. one at which the pattern projected by the second optical radiator 902 upon the build surface 403 is within the field of view of the optical imaging detector 501.

In this embodiment the way in which the second optical radiator 902 emits optical radiation may stay the same while the build platform 402 moves through said range of positions. Said movement makes the emitted optical radiation hit different parts of the build surface 403 at each position of said range of positions, so that in the end the emitted optical radiation has hit essentially all parts of the build surface 403 in turn. Knowing the pattern that the emitted optical radiation should produce on a completely flat (or otherwise well known) form of a build surface 403, if any exceptions from such an expected pattern are observed by the optical imaging detector 501, it means that there is something on the build surface 403 that shouldn't be there.

In the embodiment illustrated in FIGS. 9 to 12 the second optical radiator 902 is a laser configured to project at least one distributed reflection of laser light upon the affected part of the build surface 403. If the same relatively simple approach is used as with the embodiment of the first optical radiator 901 explained earlier, the laser in the second optical radiator 902 may comprise at least one laser source and at least one lens configured to distribute a linear laser beam produced by said laser source into a fan-like shape. The pattern that is consecutively produced on the build surface 403 is a straight line 1102 that crosses the build surface 403 at a position that depends on the height at which the build platform 402 is.

The controller of the stereolithography apparatus may be configured to execute a machine vision process to decide, whether the optical image data received from the optical imaging detector 501 indicates exceptions from a default form of the build surface 403. In the embodiment described above, in which the build surface 403 is flat and the second optical radiator 902 produces a fan-shaped laser beam, the controller could first find and select all images taken by the optical imaging detector 501 in which an observed reflection of the fan-shaped laser beam appears on the build surface 403. In each of these selected images the controller could examine the coordinates, within the coordinate system of the image frame, of those pixels that contribute to the observed reflection of the fan-shaped laser beam. The controller could fit a straight line to the coordinates of these pixels, and calculate one or more statistical descriptors that tell, how well the coordinates of said pixels obey the equation of such a fitted straight line. If any of these statistical descriptors is larger than some predetermined threshold value, the controller could decide that an exception from a default form of the build surface 403 was found.

In general, the controller may be configured to either allow the operation of the stereolithography apparatus to continue as a response to finding no exceptions from said default form of said build surface, or interrupt operation of the stereolithography apparatus as a response to finding exceptions from said default form of said build surface. Interrupting the operation may be accompanied by giving an alert to a user of the apparatus through a user interface, prompting the user to check the build surface and remove any remnants of solidified resin.

Taken that stereolithography is based on photopolymerizing only some strictly delimited portions of resin, care should be taken not to use such optical radiators for other purposes (like examining the build surface for exceptions from its default form) that could cause unintended photopolymerization. Therefore it is advisable to select the second optical radiator 902 so that it is configured to only emit optical radiation of wavelengths longer than or at most equal to a predefined cutoff wavelength. Said cutoff wavelength should be selected longer than wavelengths used to photopolymerize resins in stereolithography. Ultraviolet radiation is often used for photopolymerizing, so said cutoff wavelength could be in the range of visible light. Laser light is monochromatic, so if a laser source is used in the second optical radiator 902, the wavelength of the laser light is synonymous to said cutoff wavelength. Naturally the wavelength of the second optical radiator 902 must be selected so that its reflection is easily detectable by the optical imaging detector 501.

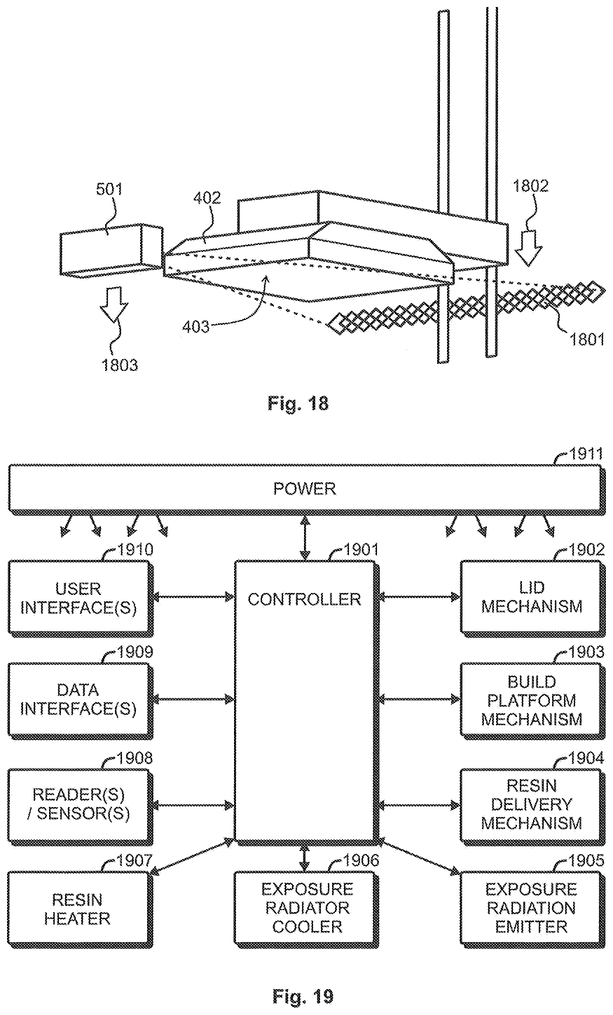

FIG. 18 illustrates an embodiment that can be used to examine the build surface for exceptions from its default form in place of or in addition to the embodiment described above. In the embodiment of FIG. 18 a pattern 1801 of some predetermined kind appears in the field of view of the optical imaging detector 501 at least when the optical imaging detector 501 is at one position. The location of the pattern 1801 has further been selected so that at some mutual positioning of the optical imaging detector 501 and the build platform 402 the latter partially covers the pattern 1801 in the field of view of the former. In particular, at said mutual positioning of the optical imaging detector 501 and the build platform 402, a view taken from the optical imaging detector 501 exactly along the build surface 403 intersects the pattern 1801.

If the build surface 403 is clean and planar, an image taken by the optical imaging detector 501 at said mutual positioning shows the pattern 1801 neatly cut along a straight line. The controller of the stereolithography apparatus may execute a machine vision process to examine, whether this is true or whether the part of the pattern 1801 visible in the image appears distorted in any way. Any distortion in the line that delimits the part of the pattern 1801 visible in the image indicates that some remnants of solidified resin may have been left on the build surface 403.

The mutual positioning of the optical imaging detector 501 and the build platform 402 that appears in FIG. 18 may be achieved for example during the movement when the build platform 402 moves down towards the starting position of stereolithographic 3D printing, as illustrated by arrow 1802 in FIG. 18. Another possibility to achieve said mutual positioning is when the optical imaging detector 501 moves downwards as illustrated by arrow 1803, as a part of a closing lid to which the optical imaging detector 501 is installed. Said mutual positioning can also be achieved by intentionally moving at least one of the build platform 402 or the optical imaging detector 501 for just this purpose and not as a part of a movement that principally serves some other purpose.

FIG. 19 is a schematic block diagram that illustrates some parts of an example of a stereolithography apparatus according to an embodiment.

A controller 1901 has a central role in the operation of the apparatus. Structurally and functionally it may be based on one or more processors configured to execute machine-readable instructions stored in one or more memories that may comprise at least one of built-in memories or detachable memories.

A lid mechanism 1902 comprises the mechanical and electrical parts that serve the purpose of moving the lid that opens or closes the working region.

A build platform mechanism 1903 comprises the mechanical and electrical parts that serve the purpose of moving the build platform between its first and second extreme positions. The build platform mechanism 1903 may also comprise parts that serve to ensure correct angular positioning of the build platform.

A resin delivery mechanism 1904 comprises the mechanical and electrical parts that serve the purpose of pumping resin into the vat, and possibly draining unused resin from the vat back into some long-term repository.

An exposure radiation emitter part 1905 comprises the mechanical, electrical, and optical parts that serve the purpose of controllably emitting radiation that causes selective photopolymerization of resin during the stereolithographic 3D printing process.

An exposure radiator cooler part 1906 comprise the mechanical, electrical, and thermal parts that serve the purpose of maintaining the exposure radiation emitter part 1905 at its optimal operating temperature.

A resin heater part 1907 comprise the mechanical, electrical, and thermal parts that serve the purpose of pre-heating the resin into a suitable operating temperature and maintaining it there during the stereolithographic 3D printing process.

A reader(s) and/or sensor(s) block 1908 comprises all devices that can be classified as readers or sensors, wherein some of the readers and sensors can also act as a writer or storing device for storing information to memories, digital circuits or similar. For example all optical imaging detectors of the kind described earlier, as well as optical radiation emitters that serve other purposes than photopolymerizing resin during the stereolithographic 3D printing process belong to the reader(s) and/or sensor(s) block 1908.

The stereolithography apparatus may comprise a data interface 1909 for exchanging data with other devices. The data interface 1909 can be used for example to receive from some other device the 3D modelling data that describes, what kind of an object should be produced through stereolithographic 3D printing. The data interface 1909 can also be used to provide diagnostic data about the operation of the stereolithography apparatus to other devices, such as a monitoring computer. Data interface may also be a common network interface connected to the Internet so that external data services, such as a cloud computing facility can be reached.

The stereolithography apparatus may comprise a user interface 1910 for exchanging information with one or more users. The user interface 1910 may comprise tangible, local user interface means for facilitating immediate interaction with a user next to the stereolithography apparatus. Additionally or alternatively the user interface 1910 may comprise software and communication means for facilitating remote operation of the stereolithography apparatus for example through a network or through an app installed on a separate user's device such as a smartphone or other personal wireless communications device.

The stereolithography apparatus may comprise a power block 1911 configured to convert operating power, such as AC from an electricity distribution network, into voltages and currents needed by the various parts of the apparatus and to safely and reliably deliver such voltages and currents to said parts of the apparatus.

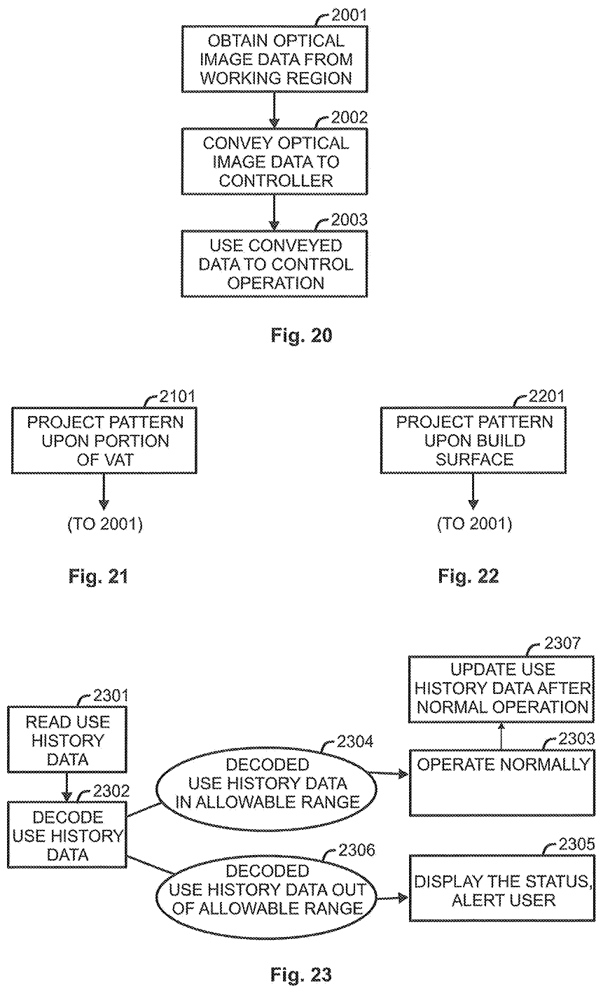

FIG. 20 illustrates schematically a method of operating a stereolithography apparatus. This embodiment of the method comprises using an optical imaging detector to obtain optical image data from at least a part of a working region of the stereolithography apparatus at step 2001. The method comprises conveying said optical image data to a controller of the stereolithography apparatus at step 2002, and using said optical image data in controlling operation of the stereolithography apparatus at step 2003.

FIG. 21 illustrates how the method may comprise, as a step 2101 prior to step 2001, a step of optically projecting a first pattern upon a portion of a vat of said stereolithography apparatus. In this case the step 2001 illustrated in FIG. 20 may comprise generating a digital representation of an optical image of said portion of said vat with said pattern projected upon it. Step 2003, on the other hand, may comprise calculating an amount of resin in said vat using said digital representation. The first pattern projected at step 2101 may be a distributed reflection of laser light upon a portion of a rim of said vat. The first pattern may comprise a line across a portion of said rim, and the method may comprise detecting from said digital representation the length of a first part of said line that optically appears different than the rest of said line.

FIG. 22 illustrates how the method may comprise, as a step 2201 prior to step 2001, a step of optically projecting a second pattern upon a build surface of a build platform of said stereolithography apparatus. In this case the step 2001 illustrated in FIG. 20 may comprise generating a digital representation of an optical image of that portion of said build surface upon which the second pattern is projected. Step 2003, on the other hand, may comprise using said digital representation to examine said build surface for exceptions from a default form of said build surface. Said second pattern may comprises a line across said part of said build surface, and the method may comprise detecting from said digital representation any optically appearing irregularities of said line. The method may further comprise comparing a representation of said second pattern found in said optical image to a default representation of said second pattern. The method may further comprise either allowing the operation of the stereolithography apparatus to continue as a response to finding said representation of said pattern to be the same as said default representation, or interrupting operation of the stereolithography apparatus as a response to finding said representation of said pattern to differ from said default representation.

FIG. 23 illustrates schematically a method of operating a stereolithography apparatus. This embodiment of the method is particularly suited for enabling the controller of the stereolithography apparatus to acquire use history so that the user can be informed about worn bottom of the vat. In other embodiments, a user may be informed or notified by an alarm about any status of a stereolithography apparatus, for example, a worn bottom of a vat, necessity of replacing a vat or part thereof, necessity of cleaning a vat, and/or other maintenance-related statuses.

The method of FIG. 23 comprises using a reader device to automatically read in use history data from a vat at step 2301. The reader device used in step 2301 may be an optical imaging detector, or it may be some other kind of reader device. Furthermore, the reading may be performed in two steps, wherein the reader reads an identifier based on which a controller can retrieve the use history data.

The method comprises also conveying the read-in parameter data to a controller of said stereolithography apparatus. In some implementations the read-in parameter data may need to be decoded, particularly when it is directly read in from a memory or similar, at step 2302, for example so that a bit string that appeared in digital image data that the controller received from an optical imaging detector or other kind of reader device is converted into a numerical value according to a predetermined decoding method. The method comprises also using a piece of said conveyed parameter data as a value of an operating parameter of said stereolithography apparatus at step 2303. The step 2302 is optional in case that the use history data can be retrieved without decoding.

The method may comprise comparing said piece of said conveyed parameter data to information indicative of an allowable range of parameter values. That kind of information may be previously stored in a memory of the stereolithography apparatus in order to ensure that it will not attempt operating with parameter values that are not safe or otherwise not recommendable. The method may comprise allowing the operation of the stereolithography apparatus to continue as a response to finding said piece of said conveyed parameter data to be within said allowable range of use history data values as illustrated with the reference designator 2304. The method may also comprise displaying use history status of a vat of the stereolithography apparatus according to step 2305, as a response to finding said piece of said conveyed parameter data to be out of said allowable range of use history values as illustrated with the reference designator 2306.

When the normal operation of the stereolithography apparatus is ended, for example, after finishing the manufactured object the updated use history data is stored at step 2307. This can be activated, for example, by removing the vat and when the stereolithography detects that the vat is not anymore attached to the apparatus, the apparatus stores the updated use history data to a computing device, such as a cloud service. If the vat comprises a memory to which the use history data is written, then similar functionality may be implemented to the removal functionality. For example, the vat may be locked to the stereolithography apparatus and the use history data is updated when the lock is opened and before the vat is released.

It is obvious to a person skilled in the art that with the advancement of technology, the basic idea of the invention may be implemented in various ways. The invention and its embodiments are thus not limited to the examples described above, instead they may vary within the scope of the claims.

1. Stereolithography apparatus, comprising:
a reader device configured to read an identifier of a vat, and
a controller coupled to said reader device and configured to receive data read in by said reader device; wherein
said data includes use history data of the vat or said controller is configured to read in use history data of the vat from a database external to the vat as a response to reading in the data, and
said controller is configured to use a piece of said use history data as a value of an operating parameter of said stereolithography apparatus or to generate an alarm.

2. A stereolithography apparatus according to claim 1, wherein the use of the piece of said use history data as a value of an operating parameter relates to a location on the bottom of the vat at which an object is to be manufactured.

3. A stereolithography apparatus according to claim 1, wherein said reader device is a wirelessly reading reader device configured to perform said reading of parameter data without direct physical contact between said reader device and said vat.

4. A stereolithography apparatus according to claim 3, wherein said reader device comprises at least one of: radio transceiver, optical imaging detector.

5. A stereolithography apparatus according to claim 4, wherein said reader device is configured to perform said reading in of use history data when said vat is in said operating position.

6. A stereolithography apparatus according to claim 5, wherein said reader device is an optical imaging detector directed so that a vat is within a field of view of said optical imaging detector.

7. A stereolithography apparatus according to claim 6, wherein said field of view of said optical imaging detector encompasses also at least one of: a portion of a resin tank of said stereolithography apparatus, a build surface of a build platform of said stereolithography apparatus in at least one position along a working movement range of said build platform.

8. A stereolithography apparatus according to claim 1, wherein said controller is configured to retrieve the use history data from a computing device using on said read identifier.

9. A stereolithography apparatus according to claim 1, wherein said controller is configured to store the use history data to said identifier or said computing device using a reader device is capable of writing said use history data to a respective location.

10. A vat for a stereolithography apparatus according to claim 1, comprising an automatically readable identifier containing use history data for use as at least one value of an operating parameter of said stereolithography apparatus.

11. A vat according to claim 10, wherein said automatically readable identifier comprises at least one of: a radio readable identifier, an optically readable identifier, a radio readable and writeable memory.

12. A method of operating a stereolithography apparatus, comprising:
using a reader device to read in an identifier of a vat,
conveying the read-in data to a controller of said stereolithography apparatus, wherein said data includes use history data of the vat or reading using said controller use history data of the vat from a database external to the vat as a response to reading in the data, and
using a piece of said use history data as a value of an operating parameter of said stereolithography apparatus or to generate an alarm.

13. A method according to claim 12, wherein the use of the piece of said use history data as a value of an operating parameter relates to a location on the bottom of the vat at which an object is to be manufactured.

14. A method according to claim 12, wherein the method comprises storing updated use history data to the identifier, wherein said identifier comprises re-writeable memory.

15. A method according to claim 12, wherein said reader device reads an identifier and further reads use history data from a computing device using said identifier.
